(19) United States
(12) Patent Application Publication
(10) Pub. No.: US 2023/0214888 A1
(43) Pub. Date: Jul. 6, 2023

(54) Systems and Methods for Analyzing Customer Reviews

(71) Applicants: Gregory Renard, REDWOOD CITY, CA (US); Chandra Bikkanur, Strongsville, OH (US); Marc Sun, Paris (FR); Audrey Duet, Santa Clara, CA (US)

(72) Inventors: Gregory Renard, REDWOOD CITY, CA (US); Chandra Bikkanur, Strongsville, OH (US); Marc Sun, Paris (FR); Audrey Duet, Santa Clara, CA (US)

(21) Appl. No.: 17/553,748

(22) Filed: Dec. 16, 2021

(51) Int. Cl. G06Q 30/02

(52) U.S. Cl. CPC G06Q 30/0282; G06Q 30/0201

(57) ABSTRACT

Systems and methods are disclosed for analyzing a customer review of a product includes extracting product categories and predicates from the customer review; extracting product features from the customer review; extracting an activity with the product features from the customer review; performing sentiment analysis using a learning machine on the customer review; determining a life scene from the customer review; and analyzing a customer opinion from the customer review.

This application claims priority to Application Serial __ entitled “SYSTEMS AND METHODS FOR PROVIDING MACHINE LEARNING OF BUSINESS OPERATIONS AND GENERATING RECOMMENDATIONS” and Application Serial __ entitled “SYSTEMS AND METHODS FOR LINKING A PRODUCT TO EXTERNAL CONTENT,” both of which are filed concurrently herewith and the contents of which are incorporated by reference.

### BACKGROUND

Customer experience (CX), is about creating exceptional customer experiences in every interaction customers have with a company. This is often called “customer experience optimization” and includes managing, optimizing, and continually improving customer experiences through behavioral analysis, predictive analytics and e-commerce.

CX is an important concern for business leaders. It is vital to have a strong CX strategy in order to remain relevant in today’s digital and in-person channels. Recent surveys of corporate board members revealed that 84% of respondents said that “improving customer experiences” was their primary goal in pursuing digital technologies.

The rules for engaging customers and providing services have become more complicated as commerce moves from the physical world to the digital. It is difficult to map the journey. Businesses must be able anticipate customer needs and provide personalized content and services. This may require new IT infrastructure and applications in some cases. The goal is to get to know customers better so that the business can increase engagement and sales.

### SUMMARY

Systems and methods are disclosed for analyzing a customer review of a product by:
extracting product categories and predicates from the customer review;
extracting product features from the customer review;
extracting an activity with the product features from the customer review;
performing sentiment analysis using a learning machine on the customer review;
determining a life scene from the customer review; and
analyzing a customer opinion from the customer review.

Implementations may include one or more of the following. The product categories and predicates are extracted from the customer review. Each product category is represented by a category name and one or more category features. The category features are extracted from the title and the content/text review. The product features are the features of the product in the customer review. The activity with the product features is extracted from the customer review. Sentiment analysis is performed on the customer review using a learning machine. A life scene is extracted from the customer review. The customer opinion is analyzed based on the life scene. For example, the products categories include sport product category and outdoor product category. In one implementation, the life scene context can be one of: ‘a life scene’, ‘a scene of life’, ‘doing sport’, ‘doing exercise’, ‘outdoor activity’, ‘relaxing’, ‘working from home’, ‘sleep or sleeping’, ‘louging or leisure activities’ ‘working at the office’, ‘traveling’, for example.

Advantages may include one or more of the following. The automation enables a company to track customer’s demands and expectations which are evolving faster than ever before. In a crowded marketplace, the system enables companies to stand out as a customer centric business to grab their attention. By effectively implementing and deploying digital technologies, the business can create a truly differentiated customer experience that creates a positive impression from customers and ultimately drives increased revenue.

### BRIEF DESCRIPTION

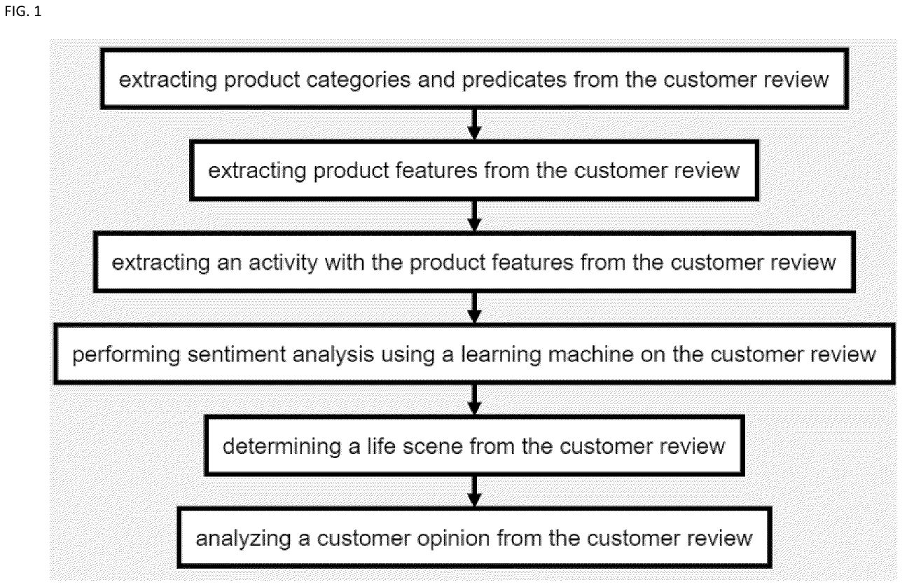

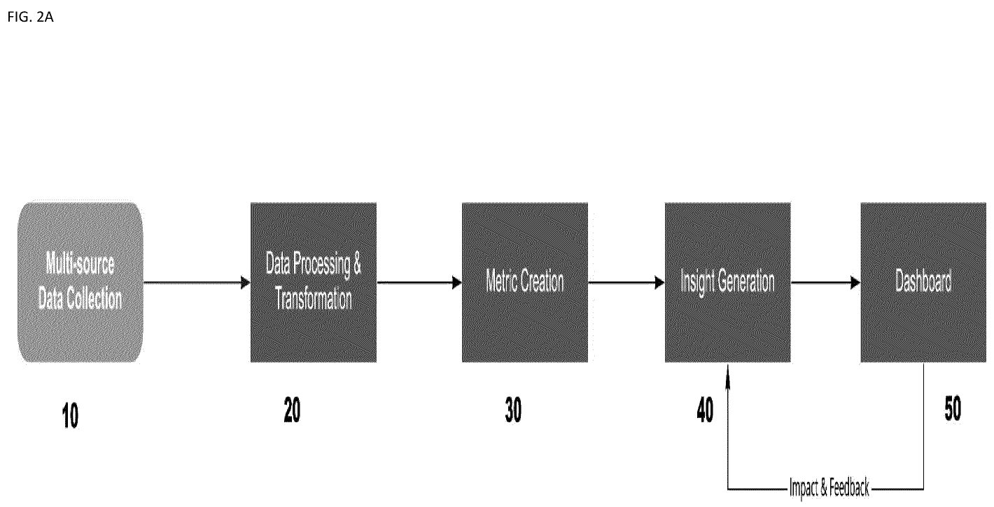

FIG. 1 shows an exemplary method for analyzing customer reviews.

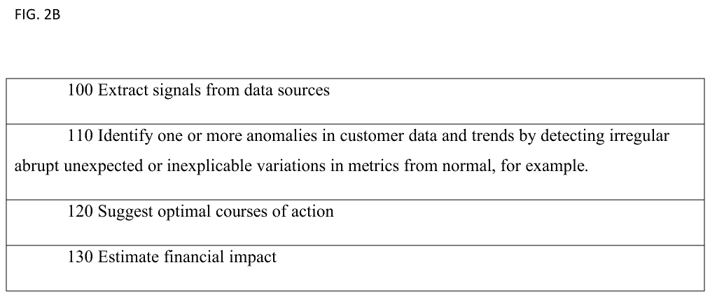

FIGS. 2A-2B show a high-level view of an exemplary system that provides automated business intelligence from business data to improve operations of the business.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, and illustrations as represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

FIG. 1 shows an exemplary method for analyzing a customer review of a product. The method includes the following:
extracting product categories and predicates from the customer review;
extracting product features from the customer review;
extracting an activity with the product features from the customer review;
performing sentiment analysis using a learning machine on the customer review;
determining a life scene from the customer review;
analyzing a customer opinion from the customer review.

A text document contains many different types of information and multiple topics. In general, extracting an opinion is not a straightforward task and requires significant domain knowledge. An opinion can be described as a subjective judgment or evaluation. People form opinions on different topics, but they tend to do so in certain ways. When asked for their opinion, most people respond with a statement that gives their own point of view on the topic at hand. The system applies a plurality of approaches to extract the opinion from the text. The first approach is to find keywords from the text that are associated with opinion statements. The second approach is to detect if the text contains an opinion by analyzing if there is any negative sentiment in the text. Additionally, the system can define a set of rules that is applied to the text to determine if the text contains an opinion. The methods described above are applied to identify the opinion from the content. The opinion is then stored in the database. The extracted opinion can be combined with the life scene context.

One implementation of FIG. 1 performs the following:
1. Pre-processing of the text;
2. Detection of the language;
3. Extract Categories and Predicates from Title of the review;
4. Extract Categories and Predicates from Content/Text of the review;
5. Merge columns of category/predicate processed text;
6. Election of the categories;
7. Extract colors from the title and the content/text review;
8. Extract product features from the title and the content/text review;
9. Extract activities from the title and the content/text review;
10. Sentiment analysis on the content/text review;
11. Chunk extraction on the title and the content/text review;
12. Modify the preprocessed text by using coreference;
13. Extract life scene from the text/content; and
14. Extract customer opinion from the text/content

The process starts by pre-processing the customer review text, which takes as input the customer review and performs lexical analysis on it. The lexical analysis component may include the following steps: tokenization - breaking the sentence into words; stemming - reducing inflected words to their base form; lemmatization - grouping together the various forms of a word to produce a single form which can be used in further analysis; dictionary lookup - retrieving the lemma and its part of speech. In addition to the aforementioned components, the text language is detected by a Linguistic Analysis component. The Linguistic Analysis component may also perform language detection, which includes identifying the language used in the customer review. The Language Detection component may include the following steps: Tokenization - breaking the sentence into words; Language Extraction - using a set of rules to identify whether the customer review is written in one of the supported languages.

The product features can be categorized as 1) basic product features and 2) attributes of the product features. Basic product features are free text extracted from the review and attribute of the product features are features extracted from the basic product features. To simplify the task, only product features from the title and the content/text review are extracted. Basic product features are extracted by applying the bag-of-words model to the title and the content/text review. Product features and attributes of the product features are extracted from the basic product features by applying the rules defined in the knowledge base. 1) Basic product features are extracted from the title and the content/text review by applying the bag-of-words model. 2) Attributes of the product features are extracted from the basic product features by applying the rules defined in the knowledge base.

A leaning machine is used to handle the remaining tasks after text pre-processing. In addition to the specific learning machine architectures mentioned below such as ZSL, the learning machine may be a Naïve Bayes classifier, a Multinomial Naïve Bayes classifier, a Multinomial Logistic Regression, a Multinomial Discriminant Analysis, a Bayesian Multinomial Logistic Regression, a Linear Support Vector Machine, a Linear Discriminant Analysis, a Quadratic Discriminant Analysis, a Gaussian Naïve Bayes classifier, a Gaussian Logistic Regression, a Gaussian Discriminant Analysis, a K-Nearest Neighbors classifier, a Fisher Linear Discriminant, a Linear Discriminant Analysis, a Quadratic Discriminant Analysis, a Bayesian Linear Discriminant Analysis, a Bayesian Quadratic Discriminant Analysis, a Gaussian Naïve Bayes classifier, a Gaussian Logistic Regression, a Gaussian Discriminant Analysis, a K-Nearest Neighbors classifier, a Fisher Linear Discriminant, a Linear Discriminant Analysis, a Quadratic Discriminant Analysis, a Bayesian Linear Discriminant Analysis, a Bayesian Quadratic Discriminant Analysis, a Gaussian Naïve Bayes classifier, for example.

The system also applies sentiment analysis, which can be done using a learning machine on the customer review. Learning machines are used to extract sentiment from sentences in a document or a collection of documents. These are trained with a labeled data set. They are supervised learning models. They are used for classification and regression. These include Naïve Bayes, Decision Trees, Logistic Regression, Support Vector Machines, Artificial Neural Networks, and many others.

The system extracts product categories and predicates from the customer review. The following are examples of product categories: 1. “a camcorder” 2. “a video camera” 3. “a notebook” 4. “a tablet” 5. “a mobile phone” 6. “a smartphone” 7. “a laptop” 8. “a desktop computer” 9. “a camera” 10. “a tv”, for example. The system then extracts product features from the customer review. The system uses a dictionary of verbs that are common in customer reviews to identify the activity with the product features. The extracted activities are then used to analyze customer opinions. Example: From a customer review: “I love this backpack, it is very comfortable to wear for long periods of time, I use it for traveling as well as for everyday use. The material is great and it looks like it will last for a long time.” Product features: A backpack (material, color, size) Activity: Wearing a backpack (traveling, everyday use) Opinion: “This backpack is very comfortable to wear for long periods of time.”

The product categories and predicates are extracted from the customer review. Each product category is represented by a category name and one or more category features. The category features are extracted from the title and the content/text review. The product features are the features of the product in the customer review. The activity with the product features is extracted from the customer review. Sentiment analysis is performed on the customer review using a learning machine. A life scene is extracted from the customer review. The customer opinion is analyzed based on the life scene. For example, the products categories include sport product category and outdoor product category.

The product features can be categorized as 1) basic product features and 2) attributes of the product features. Basic product features are free text extracted from the review and attribute of the product features are features extracted from the basic product features. To simplify the task, only product features from the title and the content/text review are extracted. Basic product features are extracted by applying the bag-of-words model to the title and the content/text review. Product features and attributes of the product features are extracted from the basic product features by applying the rules defined in the knowledge base. 1) Basic product features are extracted from the title and the content/text review by applying the bag-of-words model. 2) Attributes of the product features are extracted from the basic product features by applying the rules defined in the knowledge base.

First, the system extracts the customer reviews and all possible categories and predicates from the text. Second, the system extracts the product features from the text. Third, the system extracts the activities of the product features from the text. Fourth, the system uses a sentiment analysis approach to determine the sentiment of the customer review. Fifth, the system uses an intent extraction approach to extract the life scene from the customer review. Sixth, we use a dialog processing approach to determine the opinion of the customer review.

One implementation extracts all product categories and predicates from the title of the review. The details are as follows:

1. Extract the Title of the Review A title is the heading above a text. It should be self-explanatory without any additional interpretation.

2. Extract Product Categories and Predicates from the Title A category is a class of items (e. g. , shoes, cars, books, etc. ) that have something in common, such as features, functionality, intended use, or application. A predicate is a word or phrase that describes the subject of a sentence. In a review, the predicate is usually a verb. A predicate has one or more objects. Each object has one or more features. For example, the following text: “I bought this shoe because it is comfortable, breathable, and waterproof.” can be broken down into the following components: Shoe, Comfortable, Breathable, Waterproof. 3. Map Categories to Product Categories 3. 1. Map Categories to Product Categories When a review contains a product category, the category should be mapped to the product category in the product catalog. A product category is a classification of products based on their type, purpose, attributes, functionality, and/or other criteria.

One embodiment maps Predicates to Product Features. In this example, the input text is shown to be ‘l love the design and the quality of the product’. For the category ‘design’, there are two potential predicates that may be included in the customer’s review, namely ‘quality’ and ‘attractive’. In this example, ‘quality’ is included in the customer’s review, and so the word ‘quality’ is assigned a value of 1 for the column ‘product features’. The other possible predicate, ‘attractive’, is not included in the customer’s review, and so the word ‘attractive’ is assigned a value of 0 for the column ‘product features’. The next step is to merge the columns of category/predicate processed text with the columns of product features processed text.

If the review is focused on a product, the system extracts product categories (plural) and predicates from the customer review. The categories are predetermined in a database of categories. The predicates are predetermined in a database of predicates.

The input is a review, the output is a list of product features. The product features can be categorized as 1) basic product features and 2) attributes of the product features. Basic product features are free text extracted from the review and attribute of the product features are features extracted from the basic product features. To simplify the task, only product features from the title and the content/text review are extracted. Basic product features are extracted by applying the bag-of-words model to the title and the content/text review. Product features and attributes of the product features are extracted from the basic product features by applying the rules defined in the knowledge base. 1) Basic product features are extracted from the title and the content/text review by applying the bag-of-words model. 2) Attributes of the product features are extracted from the basic product features by applying the rules defined in the knowledge base.

Next, the process detects activities that are done with the product. For example, the activities = [‘watching TV’, ‘relaxing’, ‘reading a book’, ‘listening to music’, ‘having dinner’, ‘working from home’, ‘working at the office’, ‘traveling’, ‘doing sport’, ‘going out with friends’, ‘sleeping’, ‘louging or leisure activities’ ‘cooking’, ‘shopping’, ‘working out in the gym’, among others.

In one embodiment, the systems and methods extract product categories and predicates from the customer review. In another embodiment, the systems and methods extract product features from the customer review. In another embodiment, the systems and methods extract an activity with the product features from the customer review. In another embodiment, the systems and methods perform sentiment analysis using a learning machine on the customer review. In another embodiment, the systems and methods determine a life scene from the customer review. In another embodiment, the systems and methods analyze a customer opinion from the customer review. 10. 1 Sentiment Analysis: Sentiment analysis is the process of identifying and extracting subjective information in text or speech. One objective of sentiment analysis is to determine whether a given piece of writing is positive, negative, or neutral. A more complex goal is to characterize the emotional “polarity” of the text. The idea is to detect whether the text is generally positive or negative. A simple form of sentiment analysis can be performed using a dictionary of words that have been manually associated with a sentiment (e. g. , words like “good”, “excellent”, “wonderful”, “bad”, “terrible”, etc. ). This approach suffers from the disadvantage that it is very likely to over-predict sentiment. That is, it is likely to label as positive many sentences that are negative.

The sentiment analysis approach may include the following steps: (a) Extracting subjectivity scores from the customer review using lexical cues. (b) Extracting a list of predicates from the customer review. (c) Extracting a list of categories from the customer review. (d) Extracting a list of features from the customer review. (e) Extracting an activity from the customer review. (f) Calculating a subjectivity score for each category. (g) Calculating a subjectivity score for each predicate. (h) Calculating a subjectivity score for each feature. (i) Calculating a subjectivity score for each activity. (j) Combining the subjectivity scores of the categories, predicates, features, and activities.

The method includes identifying coreference in a text. The method includes the steps of: a) preprocessing the text by splitting the text into tokens and extracting noun phrases (NP) from the tokens, each NP comprising one or more words; b) determining a head word and one or more modifier words of each NP in the text; c) creating a coreference relation between the head word and the modifier words; d) detecting an entity if the modifier words correspond to the entity. A system for identifying coreference in a text is disclosed. The system includes: a) a preprocessor for preprocessing the text by splitting the text into tokens and extracting noun phrases (NP) from the tokens, each NP comprising one or more words; b) a detector for determining a head word and one or more modifier words of each NP in the text; c) a coreference module for creating a coreference relation between the head word and the modifier words; d) an entity detector for detecting an entity if the modifier words correspond to the entity.

The life scene refers to the context of the review in terms of what the reviewer is doing, i. e. where they are, who they are with, what they are doing etc. 12. Life scene categorization When analyzing the life scene, the system uses a dictionary to provide consistency in categorizing the life scene. This can be done by defining and creating the following categories: - doing sport - doing exercise -out door activity - relaxing - working from home - sleeping - louging or leisure activities - working at the office - traveling - other activities After the categories are defined, the life scene is categorized based on predicates in the sentence. In one implementation, the life scene context can be one of: ‘a life scene’, ‘a scene of life’, ‘doing sport’, ‘doing exercise’, ‘outdoor activity’, ‘relaxing’, ‘working from home’, ‘sleep or sleeping’, ‘louging or leisure activities’ ‘working at the office’, ‘traveling’, for example.

In one embodiment, the systems and methods extract product categories and predicates from the customer review. In another embodiment, the systems and methods extract product features from the customer review. In another embodiment, the systems and methods extract an activity with the product features from the customer review. In another embodiment, the systems and methods perform sentiment analysis using a learning machine on the customer review. In another embodiment, the systems and methods determine a life scene from the customer review. In another embodiment, the systems and methods analyze a customer opinion from the customer review. 10. 1 Sentiment Analysis: Sentiment analysis is the process of identifying and extracting subjective information in text or speech. One objective of sentiment analysis is to determine whether a given piece of writing is positive, negative, or neutral. A more complex goal is to characterize the emotional “polarity” of the text. The idea is to detect whether the text is generally positive or negative. A simple form of sentiment analysis can be performed using a dictionary of words that have been manually associated with a sentiment (e. g. , words like “good”, “excellent”, “wonderful”, “bad”, “terrible”, etc. ).

In one implementation, the identifying coreference includes the steps of: a) preprocessing the text by splitting the text into tokens and extracting noun phrases (NP) from the tokens, each NP comprising one or more words; b) determining a head word and one or more modifier words of each NP in the text; c) creating a coreference relation between the head word and the modifier words; d) detecting an entity if the modifier words correspond to the entity. A system for identifying coreference in a text is disclosed. The system includes: a) a preprocessor for preprocessing the text by splitting the text into tokens and extracting noun phrases (NP) from the tokens, each NP comprising one or more words; b) a detector for determining a head word and one or more modifier words of each NP in the text; c) a coreference module for creating a coreference relation between the head word and the modifier words; d) an entity detector for detecting an entity if the modifier words correspond to the entity. FIG is a flow chart illustrating the coreference process of the preferred embodiment. Referring to FIG , the coreference process is initiated in step 201, and proceeds to step 202 where a sentence is split into individual tokens. In step 203, noun phrases are extracted from the tokens, and the head word and one or more modifier words are identified for each noun phrase.

The life scene can be extracted from a customer review using NLP (Natural Language Processing) tools. The life scene refers to the context of the review in terms of what the reviewer is doing, i. e. where they are, who they are with, what they are doing etc. When analyzing the life scene, the system ensures that it is consistent in categorizing it. This can be done by defining and creating the following categories: - doing sport - doing exercise - outdoor activity - relaxing - working from home - sleeping -lounging or leisure activities - working at the office - traveling - other activities, for example. After the categories are defined, the life scene is categorized based on predicates in the sentence.

A text document contains many different types of information and multiple topics. The process of extracting the opinion from the text is non-trivial. In general, extracting an opinion is not a straightforward task and requires a lot of domain knowledge. We use the following approach to extract an opinion from the text. “An opinion can be described as a subjective judgment or evaluation. People form opinions on different topics, but they tend to do so in certain ways. When asked for their opinion, most people respond with a statement that gives their own point of view on the topic at hand.” We have applied various approaches to extract the opinion from the text. The first approach is to find keywords from the text that are associated with opinion statements. This approach is known as Opinion mining. The second approach is to detect if the text contains an opinion by analyzing if there is any negative sentiment in the text. We have used two sentiment analysis algorithms. One is called NRC sentiment score and the other is called Word2vec based sentiment score. Both of these approaches are used to detect the opinion in the text. We also apply a rule based approach to extract the opinion from the text. We define a set of rules that is applied to the text to determine if the text contains an opinion. The methods described above are applied to identify the opinion from the content. The opinion is then stored in the database. The extracted opinion is combined with the Life scene context.

In one embodiment, the systems and methods extract product categories and predicates from the customer review. In another embodiment, the systems and methods extract product features from the customer review. In another embodiment, the systems and methods extract an activity with the product features from the customer review. In another embodiment, the systems and methods perform sentiment analysis using a learning machine on the customer review. In another embodiment, the systems and methods determine a life scene from the customer review. In another embodiment, the systems and methods analyze a customer opinion from the customer review. 10. 1 Sentiment Analysis: Sentiment analysis is the process of identifying and extracting subjective information in text or speech. One objective of sentiment analysis is to determine whether a given piece of writing is positive, negative, or neutral. A more complex goal is to characterize the emotional “polarity” of the text. The idea is to detect whether the text is generally positive or negative. A simple form of sentiment analysis can be performed using a dictionary of words that have been manually associated with a sentiment (e. g. , words like “good”, “excellent”, “wonderful”, “bad”, “terrible”, etc. ).

One implementation of identifying coreference in text includes the steps of: a) preprocessing the text by splitting the text into tokens and extracting noun phrases (NP) from the tokens, each NP comprising one or more words; b) determining a head word and one or more modifier words of each NP in the text; c) creating a coreference relation between the head word and the modifier words; d) detecting an entity if the modifier words correspond to the entity. A system for identifying coreference in a text is disclosed. The system includes: a) a preprocessor for preprocessing the text by splitting the text into tokens and extracting noun phrases (NP) from the tokens, each NP comprising one or more words; b) a detector for determining a head word and one or more modifier words of each NP in the text; c) a coreference module for creating a coreference relation between the head word and the modifier words; d) an entity detector for detecting an entity if the modifier words correspond to the entity. FIG is a flow chart illustrating the coreference process of the preferred embodiment. Referring to FIG, the coreference process is initiated in step 201, and proceeds to step 202 where a sentence is split into individual tokens. In step 203, noun phrases are extracted from the tokens, and the head word and one or more modifier words are identified for each noun phrase.

A text document contains many different types of information and multiple topics. The process of extracting the opinion from the text is non-trivial. In general, extracting an opinion is not a straightforward task and requires a lot of domain knowledge. We use the following approach to extract an opinion from the text. “An opinion can be described as a subjective judgment or evaluation. People form opinions on different topics, but they tend to do so in certain ways. When asked for their opinion, most people respond with a statement that gives their own point of view on the topic at hand.” We have applied various approaches to extract the opinion from the text. The first approach is to find keywords from the text that are associated with opinion statements. This approach is known as Opinion mining. The second approach is to detect if the text contains an opinion by analyzing if there is any negative sentiment in the text. We have used two sentiment analysis algorithms. One is called NRC sentiment score and the other is called Word2vec based sentiment score. Both approaches are used to detect the opinion in the text. We also apply a rule-based approach to extract the opinion from the text. We define a set of rules that is applied to the text to determine if the text contains an opinion. The methods described above are applied to identify the opinion from the content. The opinion is then stored in the database. The extracted opinion is combined with the Life scene context.

In a further embodiment, systems and methods are disclosed for analyzing a customer review of a product. The method includes: extracting product categories and predicates from the customer review; extracting product features from the customer review; extracting an activity with the product features from the customer review; performing sentiment analysis using a learning machine on the customer review; determining a life scene from the customer review; analyzing a customer opinion from the customer review. The result can be used to provide personalized presentations to the customer. For example, if a customer mentions a particular sport or type of sport, then this information can be used to provide targeted offers. The system can also recommend specific products for a given life scene.

Next, detailed examples illustrating the implementations of FIG. 1 are provided.

### Pseudo Code (without Example)

1. Pre-processing of the text ( new column : processed_text) :
   1. Replace etc. by etc
   2. Replace line break (\n+) by a point
   3. Remove quotation marks (“”)
   4. Replace multiple white spaces by a single white space
2. Detection of the language ( new column : language )
   1. Use fasttext language model in order to detect the language of the processed text.
3. Extract Categories and Predicates from Title of the review ( new columns : title_categories and title_predicates )
   1. ZSL on Categories and fetch top 3 categories ( or top )
   2. Top Categories with threshold > 0.6 (or threshold). If we have no category score above the threshold, we get the categories with a score above the average score of the top categories.
   3. Gather all Predicates of Categories
   4. Run ZSL on all Predicates of Categories gathered above, fetch the top 5 predicates andand save the results above in the column title_predicates.
   5. Top Predicates with threshold > 0.6 (or threshold)
   6. Map the Predicates to the category along with the scores.
   7. Normalize the Category scores from above to a value in between 0 & 1, and save the results above in the column title_categories.
4. Extract Categories and Predicates from Content/Text of the review ( new columns : text_categories_summary, text_predicates_all and text_categories_predicates_details )
   1. Split content/text into individual sentences ( Preprocessing logic )
   2. For each sentence, repeat step 3.1 to step 3.9 and append the results to global lists: zsl_final_content and zsl_result_all_content
   3. Also append sentence level category and predicates details to the global list: zsl_details_to_save
   4. Once all the sentences are processed, save the global lists as new columns: text_categories_summary, text_predicates_all and text_categories_predicates_details in the same order
5. Merge columns : ( new columns : categories_with_polarity, categories_without_polarity, categories_without_polarity_list)
   1. Merge title_categories and text_categories_summary based on polarity/sentiment On to create a new column: categories_with_polarity
   2. Merge title_categories and text_categories_summary based on polarity/sentiment Off to create a new column: categories_without_polarity
   3. Aggregate all lists of categories from categories_without_polarity to create a new column: categories_without_polarity_list
6. Election of the categories ( new column : categories_election, categories_election_2, merge_labels )
   1. Get categories from categories_with_polarity with a score above the mean value of categories_with_polarity * 0.6 ( or threshold ) and store the results in the column categories_election
   2. Compute the difference between the polarities of the same categories and add the label POS / NEG to the category’s name depending if the difference is positive or negative. Then, select categories with a score above the mean value of categories_with_polarity * 0.6 ( or threshold ). Compute the percentage of each category and store all the results in the column categories_election2.
   3. Merge labels by calculating the mean for each label from categories_election and categories_election2 and store them in the column merged_labels
7. Extract colors from the title and the content/text review ( new column : colors, modified column : ‘text categories_predicates details’)
   1. Extract colors from title and content/text review if COLOR label is in ‘merged_labels’ and store the results in colors columns
   2. For each sentence in the text_categories_predicates_details column, extract the colors and store it in the same column.
8. Extract product features from the title and the content/text review ( new column : product_features_extracted; modified column : ‘text_categories_predicates_details’)
   1. Extract product features from title and content/text review and store the results in product_features_extracted columns
   2. For each sentence in the text_categories_predicates_details column, extract the product features and store it in the same column.
9. Extract activities from the title and the content/text review ( new column : activities_extracted; modified column : ‘text_categories_predicates_details’)
   1. Extract activities from title and content/text review and store the results in activities_extracted columns
   2. For each sentence in the text_categories_predicates_details column, extract the product features and store it in the same column.
10. Sentiment analysis on the content/text review ( new column : sentimen_analysis; modified column : ‘text_categories_predicates_details’)
   1. For each sentence of the review, do a sentiment analysis. Store the results in sentimen_analysis column and modify text_categories_predicates_details column
11. Chunk extraction on the title and the content/text review ( new column : chunks_extracted, chunks_extracted2)
   1. Extract chunks for the title and each sentence and store it in chunks_extracted.
   2. Extract chunks for the title and each sentence by using merged_labels and the rating column and store it in chunks_extracted2.
12. Modify the preprocessed text by using coreference (new column : coreferenced_text)
   1. Run Coreference model on top of the preprocessed text column and store the result in the column coreferenced_text
13. Extract life scene from the text/content ( new column : life_scene_extracted; modified column : text_categories_predicates_details)
   1. Do the steps below for each sentence :
   2. Get the co-reference sentence
   3. Run Life scene ZSL on the co-reference sentence, fetch top 2 and calculate the average score.
   4. Run OIE ( Open information extraction ) on the sentence and extract words with specific tags.
   5. Run Life scene ZSL on the string formed from the list extracted above, fetch top 2 and calculate the average score.
   6. Extract verbs from the co-reference sentence
   7. Run Life scene ZSL on the string formed from the verbs extracted above, fetch top 3 and calculate the average score.
   8. Calculate the average score of the three ZSL average scores above. If the score is superior to 0.8, add activities_extracted column to the life_scene_extracted column and update ‘text_categories_predicates_details’ column with the life scene.
14. Extract customer opinion from the text/content ( new column: customer_opinion; modified column : text categories_predicates details
   1. Do the steps below for each sentence :
   2. Get the co-reference sentence
   3. Run Opinion ZSL on co-reference sentences, fetch top 2 and calculate the average score.
   4. Run OIE ( Open information extraction ) on the sentence and extract words with specific tags.
   5. Run Opinion ZSL on the string formed from the list extracted above, fetch top 2 and calculate the average score.
   6. Extract verbs from the co-reference sentence
   7. Run Opinion ZSL on the string formed from the verbs extracted above, fetch top 3 and calculate the average score.
   8. Calculate the average score of the three ZLS average scores above. If the score is superior to 0.8, update customer_opinion and text_categories_predicates_details column with the top predicate fetched from the Opinion ZSL on co-reference sentences.

### Pseudo Code (with an Example)

Title : Good material

Text: I purchased the red one, it is a very beautiful color which is perfect for hiking in the woods. The material is soft and breathable, Incan warring it all day with layer match. The only thing is my crossbody handbag scratched the side of pocket, I don’t know why.

1. Pre-processing of the text ( new column : processed_text) :
1. Replace etc. by etc
2. Replace line break ( \n+ ) by a point
3. Remove quotation marks (“”)
4. Replace multiple white spaces by a single white space

Input :
text = ‘l purchased the red one , it is a very beautiful color which is perfect for hiking in the woods. The material is soft and breathable, Incan warring it all day with layer match. The only thing is my crossbody handbag scratched the side of pocket, I don’t know why.’

Output :
‘l purchased the red one , it is a very beautiful color which is perfect for hiking in the woods. The material is soft and breathable, Incan warring it all day with layer match. The only thing is my crossbody handbag scratched the side of pocket, I don’t know why.’

2. Detection of the language ( new column : language )
2. Use fasttext language model in order to detect the language of the processed text.

Input:
processed_text = ‘l purchased the red one , it is a very beautiful color which is perfect for hiking in the woods. The material is soft and breathable, Incan warring it all day with layer match. The only thing is my crossbody handbag scratched the side of pocket, I don’t know why.’

Output :
‘en’

3. Extract Categories and Predicate from Title of the review ( new columns : title_categories and title_predicates )
8. ZSL on Categories and fetch top 3 categories ( or top )
9. Top Categories with threshold > 0.6 (or threshold). If we have no category score above the threshold, we get the categories with a score above the average score of the top categories.
10. Gather all Predicates of Categories
11. Run ZSL on all Predicates of Categories gathered above, fetch the top 5 predicates adn save the results above in the column title_predicates.
12. Top Predicates with threshold > 0.6 (or threshold)
13. Map the Predicates to the category along with the scores.
14. Normalize the Category scores from above to a value in between 0 & 1, and save the results above in the column title_categories.

Input:
title = ‘Good material’
Categories = [‘Quality’, ‘Purchase’, ‘Return Policy’, ‘Price’, ‘Size’, ‘Design’, ‘Color’, ‘Description Matching’, ‘Fabric Texture’, ‘Shipping’, ‘Laundry Washing’, ‘Warm Or Cool’]
dict_cat_predicates = {‘Color’: [‘a clothing or product that is with the right color’, ‘a clothing or product bought that is not the color expected’, ... ], ‘Size’: [‘a clothing item with the size being perfect’, ‘a clothing item with a problem with the size’, ... ], ... }
dict_predicates = {‘a clothing or product that is with the right color’: ‘Color_POS’, ‘a clothing or product bought that is not the color expected’: ‘Color_NEG’,‘a clothing or product that is with the right tint’: ‘Color_POS’, ... }

Output (title_predicates) :
‘[[“a clothing or product with a great quality”, 0.9994115233421326], [“a clothing item with the perfect quality”, 0.9953521490097046], [“a product with a quality that is exceeding expectations”, 0.9615597724914551], [“a product exceeding expectations”, 0.656135082244873], [“a product not meeting the expectation”, 0.0007951834122650325]]’

Output (title_categories) :
‘{“Quality_POS”: 1.0}’

4. Extract Categories and Predicates from Content/Text of the review ( new columns : text_categories_summary, text_predicates_all and text_categories_predicates_details )
5. Split content/text into individual sentences ( Preprocessing logic )
6. For each sentence, repeat step 3.1 to step 3.9 and append the results to global lists: zsl_final_content and zsl_result_all_content
7. Also append sentence level category and predicates details to the global list: zsl_details_to_save
8. Once all the sentences are processed, save the global lists as new columns: text_categories_summary, text_predicates_all and text_categories_predicates_details in the same order

Input :
processed_text = “I purchased the red one , it is a very beautiful color which is perfect for hiking in the woods. The material is soft and breathable, Incan warring it all day with layer match. The only thing is my crossbody handbag scratched the side of pocket, I don’t know why.’
Categories = [‘Quality’, ‘Purchase’, ‘Return Policy’, ‘Price’, ‘Size’, ‘Design’, ‘Color’, ‘Description Matching’, ‘Fabric Texture’, ‘Shipping’, ‘Laundry Washing’, ‘Warm Or Cool’]
dict_cat_predicates = {‘Color’: [‘a clothing or product that is with the right color’, ‘a clothing or product bought that is not the color expected’, ... ], ‘Size’: [‘a clothing item with the size being perfect’, ‘a clothing item with a problem with the size’, ... ], ... }
dict_predicates = {‘a clothing or product that is with the right color’: ‘Color_POS’, ‘a clothing or product bought that is not the color expected’: ‘Color_NEG’,‘a clothing or product that is with the right tint’: ‘Color_POS’, ... }

Output (text_categories_summary) :
‘{“Color_POS”: 0.5507, “Quality_POS”: 0.227, “Price_NEG”: 0.0994, “Purchase_NEG”: 0.0615, “Color_NEG”: 0.0614}’

Output (text_predicates_all) :
‘[[“a clothing or product that is with the right shade”, 0.9985200762748718], [“a clothing or product that is with the right color”, 0.998308539390564], [“a clothing or product that is with the right tone”, 0.9967826008796692], ... ]

Output (text_categories_predicates_details) :
‘[{“sent”: “I purchased the red one”, “categories”: {“Color_POS”: 0.801, “Color_NEG”: 0.199}, “predicates”: [[“a clothing or product that is with the right shade”, 0.9985200762748718], [“a clothing or product that is with the right color”, 0.998308539390564], [“a clothing or product that is with the right tone”, 0.9967826008796692], [“a clothing or product that is with the right tint”, 0.9936699867248535], [“a clothing or product bought that is not the shade expected”, 0.99058997631073]]}, ... ]’

5. Merge columns : ( new columns : categories_with_polarity, categories_without_polarity, categories_without_polarity_list)
1. Merge title_categories and text_categories_summary based on polarity/sentiment On to create a new column: categories_with_polarity
2. Merge title_categories and text_categories_summary based on polarity/sentiment Off to create a new column: categories_without_polarity
3. Aggregate all lists of categories from categories_without_polarity to create a new column: categories_without_polarity_list

Input :
title_categories = ‘{“Quality_POS”: 1.0}’
text_categories_summary = ‘{“Color_POS”: 0.5507, “Quality_POS”: 0.227, “Price_NEG”: 0.0994, “Purchase_NEG”: 0.0615, “Color_NEG”: 0.0614}’

Output (categories_with_polarity) :
‘{“Quality_POS”: 1.227, “Color_POS″: 0.5507, “Price_NEG”: 0.0994, “Purchase_NEG”: 0.0615, “Color_NEG”: 0.0614}’

Output (categories_without_polarity) :
‘{“Quality”: 1.227, “Color”: 0.6121, “Price”: 0.0994, “Purchase”: 0.0615}’ Output (categories_without_polarity_list) :
‘[“Quality”, “Color”, “Price”, “Purchase”]’

6. Election of the categories ( new column : categories_election, categories_election_2, merge_labels )
4. Get categories from categories_with_polarity with a score above the mean value of categories_with_polarity * 0.6 ( or threshold ) and store the results in the column categories_election
5. Compute the difference between the polarities of the same categories and add the label POS / NEG to the category’s name depending if the difference is positive or negative. Then, select categories with a score above the mean value of categories_with_polarity * 0.6 ( or threshold ). Compute the percentage of each category and store all the results in the column categories_election2.
6. Merge labels by calculating the mean for each label from categories_election and categories_election2 and store them in the column merged_labels

Input :
categories_with_polarity = ‘{“Quality_POS″: 1.227, “Color_POS″: 0.5507, “Price_NEG”: 0.0994, “Purchase_NEG”: 0.0615, “Color_NEG”: 0.0614}’

Output (categories_election) :
{‘Quality_POS’: 1.227, ‘Color_POS’: 0.5507}

Output (categories_election2) :
‘({‘Quality_POS’: 1.227, ‘Color_POS’: 0.4893},
{‘Quality_POS’: 71.49, ‘Color_POS’: 28.51})

Output ( merged_labels )
‘{“Quality_POS”: 1.227, “Color_POS”: 0.52}’

7. Extract colors from the title and the content/text review ( new column : colors, modified column : ‘text categories_predicates details’)
3. Extract colors from title and content/text review if COLOR label is in ‘merged_labels’ and store the results in colors columns
4. For each sentence in the text_categories_predicates_details column, extract the colors and store it in the same column.

Input:
‘merged_labels’ = ‘{“Quality_POS”: 1.227, “Color_POS”: 0.52}’
‘title’ = ‘Good material’
“preprocessed_text’ = ‘I purchased the red one , it is a very beautiful color which is perfect for hiking in the woods. The material is soft and breathable, Incan warring it all day with layer match. The only thing is my crossbody handbag scratched the side of pocket, I don’t know why.’
‘text_categories_predicates_details’ = ‘[{“sent”: “I purchased the red one”, “categories”: {“Color_POS”: 0.801, “Color_NEG”: 0.199}, “predicates”: [[“a clothing or product that is with the right shade”, 0.9985200762748718], [“a clothing or product that is with the right color”, 0.998308539390564], [“a clothing or product that is with the right tone”, 0.9967826008796692], [“a clothing or product that is with the right tint”, 0.9936699867248535], [“a clothing or product bought that is not the shade expected”, 0.99058997631073]]}, ... ]’

Output (colors) :
[‘red one’]

Output ( ‘text_categories_predicates_details’ ) :
‘[{“sent”: “I purchased the red one”, “categories”: {“Color_POS”: 0.801, “Color_NEG”: 0.199}, “predicates”: [[“a clothing or product that is with the right shade”, 0.9985200762748718], [“a clothing or product that is with the right color”, 0.998308539390564], [“a clothing or product that is with the right tone”, 0.9967826008796692], [“a clothing or product that is with the right tint”, 0.9936699867248535], [“a clothing or product bought that is not the shade expected”, 0.99058997631073]], “colors”: [“red one”]}, ... ]

8. Extract product features from the title and the content/text review ( new column : product_features_extracted; modified column : ‘text_categories_predicates_details’)
3. Extract product features from title and content/text review and store the results in product_features_extracted columns
4. For each sentence in the text_categories_predicates_details column, extract the product features and store it in the same column.

Input:
‘title’ = ‘Good material’
“preprocessed_text’ = ‘I purchased the red one , it is a very beautiful color which is perfect for hiking in the woods. The material is soft and breathable, Incan warring it all day with layer match. The only thing is my crossbody handbag scratched the side of pocket, I don’t know why.’
‘text_categories_predicates_details’ = ‘[{“sent”: “I purchased the red one”, “categories”: {“Color_POS”: 0.801, “Color_NEG”: 0.199}, “predicates”: [[“a clothing or product that is with the right shade”, 0.9985200762748718], [“a clothing or product that is with the right color”, 0.998308539390564], [“a clothing or product that is with the right tone”, 0.9967826008796692], [“a clothing or product that is with the right tint”, 0.9936699867248535], [“a clothing or product bought that is not the shade expected”, 0.99058997631073]], “colors”: [“red one”]}, ... ]

Output (product_features_extracted) :
[‘pocket’]

Output ( ‘text_categories_predicates_details’ ) :
{ ... , {“sent”: “The only thing is my crossbody handbag scratched the side of pocket”, “categories”: {“Purchase_NEG”: 1.0}, “predicates”: [[“a package or product that was damaged”, 0.9916825294494629], [“receiving the item purchased or ordered”, 0.0867861658334732], [“receiving the wrong item”, 0.0049591511487960815], [“a package containing exactly what was purchased”, 0.00229451060295105], [“a package that was not purchased”, 0.001267512678168714]], “colors”: [], “product_features_extracted”: [“pocket”]}, ... }

9. Extract activities from the title and the content/text review ( new column : activities_extracted; modified column : ‘text_categories_predicates_details’)
3. Extract activities from title and content/text review and store the results in activities_extracted columns
4. For each sentence in the text_categories_predicates_details column, extract the product features and store it in the same column.

Input:
‘title’ = ‘Good material’
“preprocessed_text’ = ‘I purchased the red one , it is a very beautiful color which is perfect for hiking in the woods. The material is soft and breathable, Incan warring it all day with layer match. The only thing is my crossbody handbag scratched the side of pocket, I don’t know why.’
‘text_categories_predicates_details’ = { ... , {“sent”: “The only thing is my crossbody handbag scratched the side of pocket”, “categories”: {“Purchase_NEG”: 1.0}, “predicates”: [[“a package or product that was damaged”, 0.9916825294494629], [“receiving the item purchased or ordered”, 0.0867861658334732], [“receiving the wrong item”, 0.0049591511487960815], [“a package containing exactly what was purchased”, 0.00229451060295105], [“a package that was not purchased”, 0.001267512678168714]], “colors”: [], “product_features_extracted”: [“pocket”]}, ... }

Output (activities_extracted) :
[‘hiking’]

Output ( ‘text_categories_predicates_details’ ) :
{ ... , {“sent”: “it is a very beautiful color which is perfect for hiking in the woods”, “categories”: {“Color_POS”: 1.0}, “predicates”: [[“a clothing or product that is with the right color”, 0.9982141256332397], [“a clothing or product that is with the right shade”, 0.9973650574684143], [“a clothing or product that is with the right tone”, 0.9966385364532471], [“a clothing or product that is with the right tint”, 0.993150532245636], [“a clothing that does not lose its color”, 0.9128230810165405]], “colors”: [], “product_features_extracted”: [], “activities_extracted”: [“hiking”]}, ... }

10. Sentiment analysis on the content/text review ( new column : sentimen_analysis; modified column : ‘text_categories_predicates_details’)
2. For each sentence of the review, do a sentiment analysis. Store the results in sentimen_analysis column and modify text_categories_predicates_details column

Input :
“preprocessed_text’ = ‘I purchased the red one , it is a very beautiful color which is perfect for hiking in the woods. The material is soft and breathable, Incan warring it all day with layer match. The only thing is my crossbody handbag scratched the side of pocket, I don’t know why.’
‘text_categories_predicates_details’ = { ... , {“sent”: “The only thing is my crossbody handbag scratched the side of pocket”, “categories”: {“Purchase_NEG”: 1.0}, “predicates”: [[“a package or product that was damaged”, 0.9916825294494629], [“receiving the item purchased or ordered”, 0.0867861658334732], [“receiving the wrong item”, 0.0049591511487960815], [“a package containing exactly what was purchased”, 0.00229451060295105], [“a package that was not purchased”, 0.001267512678168714]], “colors”: [], “product_features_extracted”: [“pocket”]}, ... }

Output (sentimen_analysis) :
[{‘I purchased the red one’: {‘label’: ‘POSITIVE’,
‘score’: 0.9695073962211609}},
{‘it is a very beautiful color which is perfect for hiking in the woods’: {‘label’: ‘POSITIVE’,
‘score’: 0.9998574256896973}},
{‘The material is soft and breathable’: {‘label’: ‘POSITIVE’,
‘score’: 0.9998573660850525}},
{‘Incan warring it all day with layer match’: {‘label’: ‘NEGATIVE’,
‘score’: 0.9513073563575745}},
{‘The only thing is my crossbody handbag scratched the side of pocket’: {‘label’: ‘NEGATIVE’,
‘score’: 0.999343752861023}},
{‘I don’t know why’: {‘label’: ‘NEGATIVE’, ‘score’: 0.9990879893302917}}]

Output ( ‘text_categories_predicates_details’ ) :
{ ... ,{“sent”: “it is a very beautiful color which is perfect for hiking in the woods”, “categories”: {“Color_POS″: 1.0}, “predicates”: [[“a clothing or product that is with the right color”, 0.9982141256332397], [“a clothing or product that is with the right shade”, 0.9973650574684143], [“a clothing or product that is with the right tone”, 0.9966385364532471], [“a clothing or product that is with the right tint”, 0.993150532245636], [“a clothing that does not lose its color”, 0.9128230810165405]], “colors”: [], “product_features_extracted”: [], “activities_extracted”: [“hiking”], “sentimen_analysis”: {“label”: “POSITIVE”, “score”: 0.9998574256896973}}, ... }

11. Chunk extraction on the title and the content/text review ( new column : chunks_extracted, chunks_extracted2)
3. Extract chunks for the title and each sentence and store it in chunks_extracted.
4. Extract chunks for the title and each sentence by using merged_labels and the rating column and store it in chunks_extracted.

Input:
title = ‘Good Material’
rating = ‘5’
merged_labels = ‘{“Quality_POS”: 1.227, “Color_POS″: 0.52}’
‘text_categories_predicates_details’ = { ... , {“sent”: “The only thing is my crossbody handbag scratched the side of pocket”, “categories”: {“Purchase_NEG”: 1.0}, “predicates”: [[“a package or product that was damaged”, 0.9916825294494629], [“receiving the item purchased or ordered”, 0.0867861658334732], [“receiving the wrong item”, 0.0049591511487960815], [“a package containing exactly what was purchased”, 0.00229451060295105], [“a package that was not purchased”, 0.001267512678168714]], “colors”: [], “product_features_extracted”: [“pocket”]}, ... }

Output (chunks_extracted) :
[‘a very beautiful color which is perfect for hiking in the woods’,
‘the red one’,
‘soft and breathable’,
‘a very beautiful color’,
‘my crossbody handbag scratched the side of pocket’,
‘with layer match’,
‘The only thing’,
‘my crossbody handbag’]

Output ( chunks_extracted2 ) :
[{‘Quality_POS‘: [‘material soft and breathable’]},
{‘Color_POS’: [‘very beautiful color be perfect hike wood’]}]

12. Modify the preprocessed text by using coreference (new column : coreferenced_text)

Input :
“preprocessed_text’ = ‘I purchased the red one , it is a very beautiful color which is perfect for hiking in the woods. The material is soft and breathable, Incan warring it all day with layer match. The only thing is my crossbody handbag scratched the side of pocket, I don’t know why.’

Output (coreferenced_text) :
“I purchased the red one , the red one is a very beautiful color which is perfect for hiking in the woods. The material is soft and breathable, Incan warring The material all day with layer match. The only thing is I’s crossbody handbag scratched the side of pocket, I don’t know why.”

13. Extract life scene from the text/content ( new column : life_scene_extracted; modified column : text_categories_predicates_details)
9. Iterate through each sentence
10. Get co-reference sentence
11. Run Life scene ZSL on co-reference sentences, fetch top 2 and calculate the average score.
12. Run OlE ( Open information extraction ) on the sentence and extract words with specific tags.
13. Run Life scene ZSL on the string formed from the list extracted above, fetch top 2 and calculate the average score.
14. Extract verbs from the co-reference sentence
15. Run Life scene ZSL on the string formed from the verbs extracted above, fetch top 3 and calculate the average score.
16. Calculate the average score of the three ZLS average scores above. If the score is superior to 0.8, add activities_extracted column to the life_scene column and update ‘text_categories_predicates_details’ column with the life scene.

Input:
activities_extracted = [“hiking”]
life_scene_context = [‘a life scene’, ‘a scene of life’, ‘doing sport’, ‘doing exercise’, ‘outdoor activity’, ‘relaxing’, ‘working from home’, ‘sleep or sleeping’, ‘louging or leisure activities’ ‘working at the office’, ‘traveling’,... ]
‘text_categories_predicates_details’ = { ... , {“sent”: “The only thing is my crossbody handbag scratched the side of pocket”, “categories”: {“Purchase_NEG”: 1.0}, “predicates”: [[“a package or product that was damaged”, 0.9916825294494629], [“receiving the item purchased or ordered”, 0.0867861658334732], [“receiving the wrong item”, 0.0049591511487960815], [“a package containing exactly what was purchased”, 0.00229451060295105], [“a package that was not purchased”, 0.001267512678168714]], “colors”: [], “product_features_extracted”: [“pocket”]}, ... }

Output ( ‘life_scene_extracted’ ) :
[‘hiking’]

Output ( ‘text_categories_predicates_details’ ) :
{ ... , {“sent”: “it is a very beautiful color which is perfect for hiking in the woods”, “categories”: {“Color_POS″: 1.0}, “predicates”: [[“a clothing or product that is with the right color”, 0.9982141256332397], [“a clothing or product that is with the right shade”, 0.9973650574684143], [“a clothing or product that is with the right tone”, 0.9966385364532471], [“a clothing or product that is with the right tint”, 0.993150532245636], [“a clothing that does not lose its color”, 0.9128230810165405]], “colors”: [], “product_features_extracted”: [], “activities_extracted”: [“hiking”], “sentimen_analysis”: {“label”: “POSITIVE”, “score”: 0.9998574256896973}, “chunks”: null, “life_scene_extracted”: [“hiking”]}, ... }

14. Extract customer opinion from the text/content ( new column: customer_opinion; modified column : text categories_predicates details
9. Iterate through each sentence
10. Get co-reference sentence
11. Run Opinion ZSL on co-reference sentences, fetch top 2 and calculate the average score.
12. Run OIE ( Open information extraction ) on the sentence and extract words with specific tags.
13. Run Opinion ZSL on the string formed from the list extracted above, fetch top 2 and calculate the average score.
14. Extract verbs from the co-reference sentence
15. Run Opinion ZSL on the string formed from the verbs extracted above, fetch top 3 and calculate the average score.
16. Calculate the average score of the three ZLS average scores above. If the score is superior to 0.8, update customer_opinion and text_categories_predicates_details column with the top predicate fetched from the Opinion ZSL on co-reference sentences.

Input:
customer_opinion_context = [‘recommending the product’, ‘recommending a product improvement’, ‘buying recommendation’, ‘complaining about a product’]
‘text_categories_predicates_details’ = { ... , {“sent”: “The only thing is my crossbody handbag scratched the side of pocket”, “categories”: {“Purchase_NEG”: 1.0}, “predicates”: [[“a package or product that was damaged”, 0.9916825294494629], [“receiving the item purchased or ordered”, 0.0867861658334732], [“receiving the wrong item”, 0.0049591511487960815], [“a package containing exactly what was purchased”, 0.00229451060295105], [“a package that was not purchased”, 0.001267512678168714]], “colors”: [], “product_features_extracted”: [“pocket”]}, ... }

Output ( customer_opinion ) :
[]

Output ( ‘text_categories_predicates_details’ ) :
[{“sent”: “I purchased the red one”, “categories”: {“Color_POS″: 0.801, “Color_NEG”: 0.199}, “predicates”: [[“a clothing or product that is with the right shade”, 0.9985200762748718], [“a clothing or product that is with the right color”, 0.998308539390564], [“a clothing or product that is with the right tone”, 0.9967826008796692], [“a clothing or product that is with the right tint”, 0.9936699867248535], [“a clothing or product bought that is not the shade expected”, 0.99058997631073]], “colors”: [“red one”], “product_features_extracted”: [], “activities_extracted”: [], “sentimen_analysis”: {“label”: “POSITIVE”, “score”: 0.9695073962211609}, “chunks”: null, “chunks_lemma”: null, “life_scene_extracted”: [], “customer_opinion”: []}, ...]

FIG. 2A shows a high-level view of an exemplary system that provides automated business intelligence from business data to improve operations of the business. The system extracts signals from any unstructured data source.

FIG. 2B shows an exemplary process to provide recommendations to users based on machine learning. The process includes:
100 Extract signals from data sources
110 Identify one or more anomalies in customer data and trends
120 Suggest optimal courses of action
130 Estimate financial impact

More details on the process of FIGS. 2A-2B are discussed in the co-pending incorporated by reference applications mentioned herein.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method for analyzing a customer review of a product, comprising:
extracting product categories and predicates from the customer review;
extracting product features from the customer review;
extracting an activity with the product features from the customer review;
performing sentiment analysis using a learning machine on the customer review;
determining a life scene from the customer review; and
analyzing a customer opinion from the customer review.

2. The method of claim 1, comprising applying a language model to detect a language of the customer review.

3. The method of claim 1, comprising extracting the customer opinion from a review title or review content.

4. The method of claim 1, comprising extracting categories and predicates from a review title or review content.

5. The method of claim 1, comprising determining a polarity of the product category and electing the category.

6. The method of claim 1, comprising extracting product features from a review title or review content.

7. The method of claim 1, comprising extracting a user activity with the product from a review title or review content.

8. The method of claim 1, comprising performing sentiment analysis from a review title or review content.

9. The method of claim 1, comprising performing chunk extraction on a review title or review content.

10. The method of claim 1, comprising extracting a life scene from a review title or review content.

11. The method of claim 1, comprising modifying the preprocessed text by using coreference.

12. A method, comprising:
capturing data from one or more business operational data sources;
extracting signals from one or more unstructured data sources;
automatically associating a product or a service with external content by:
characterizing the product from unstructured data sources including a product text or text from similar products;
generating a label for the product or service;
applying the label as a search engine;
extracting signals relating to the product or service;
adding data from a customer review by:
extracting product categories and predicates from the customer review;
extracting product features from the customer review;
extracting an activity with the product features from the customer review;
performing sentiment analysis using a learning machine on the customer review;
determining a life scene from the customer review; and
analyzing a customer opinion from the customer review; generating one or more metrics from the operational data and unstructured data sources;
identifying one or more anomalies from the metrics; and
suggesting predetermined courses of action and estimated financial impact.
